(19) United States
(12) Patent Application Publication
(10) Pub. No.: US 2026/0054445 A1
(43) Pub. Date: Feb. 26, 2026

(54) Methods and apparatuses for forming plastics material preforms into plastics material containers with determination of a switching time delay of valves

(71) Applicant: KRONES AG, Neutraubling (DE)

(72) Inventors: Benedikt HENGL, Essing (DE); Markus KULZER, Zell (DE); Sebastian KIRCHMAYER, Geiselhöring (DE); Daniel VOGLER, Neutraubling (DE)

(21) Appl. No.: 19/288,828

(22) Filed: Aug. 1, 2025

(30) Foreign Application Priority Data
Aug. 23, 2024 (DE) 102024124195.0

(51) Int. Cl. B29C 49/78; B29C 49/36; B29L 31/00

(52) U.S. Cl. CPC B29C 49/783; B29C 49/36; B29C 2049/7832; B29C 2049/78805; B29L 2031/712

(57) ABSTRACT

Disclosed is a method for operating a forming device for forming plastics material preforms into plastics material containers, wherein the forming device has a movable carrier on which a plurality of forming stations are arranged, wherein each of these forming stations forms plastics material preforms into the plastics material containers by applying a flowable and, in particular, gaseous medium in an operation mode, wherein in the operation mode at least two different pressure levels are applied to the plastics material preforms for the expansion thereof and at least two valves are used for this application, wherein at least one measured value is determined, at least at times, which is characteristic of a switching time and/or a switching time delay of at least one of the valves, wherein this measured value results from a pressure measured value.

### CROSS REFERENCE TO RELATED APPLICATION

This application claims priority to German Patent Application Serial No. 102024124195.0, filed Aug. 23, 2024, the contents of which are incorporated herein by reference.

### BACKGROUND OF THE INVENTION

The present invention relates to an apparatus and a method for forming plastics material preforms into plastics material containers. Such methods and apparatuses have long been known from the prior art. Heated plastics material preforms are usually formed into plastics material containers by applying compressed air to the plastics material preforms. In the current state of the art, several pressure stages are usually used to expand the plastics material preforms. For example, a pre-blowing pressure is used as well as a final blowing pressure which is higher than the pre-blowing pressure. Several valves are usually used to control the pressure application.

Due to the system, such valves usually have a valve switching delay. This means that a certain amount of time passes after the valve has been switched until it actually moves to another valve position. Machines known from the prior art usually do not take this switching time loss into account. This can lead to overflow between two pressure levels, for example.

Newer machines known from the prior art take this switching time delay into account within the framework of machine parameters. In this way, unwanted overflow is prevented and the valves installed in each case or switching characteristics thereof can be individually taken into account.

However, during ongoing operation, switching time delays may occur or the switching time delays may change slightly due, for example, to wear and tear on the valves.

Therefore, if rigid machine parameters are stored, this error will not be compensated. It is known that the machine parameters can be changed, at least with higher user rights. However, there is a risk of incorrect entries, which can lead, in particular, to higher air consumption.

The present invention is therefore based on the object of taking into account a compensation of changed valve switching time delays.

### SUMMARY OF THE INVENTION

In a method according to the invention for operating a forming device for forming plastics material preforms into plastics material containers, this forming device has a movable and, in particular, rotatable carrier on which a plurality of forming stations are arranged, wherein each of these forming stations, in an operation mode (of the forming device), forms (and, in particular, expands) plastics material preforms into the plastics material containers by applying a flowable and, in particular, gaseous medium (to the plastics material preforms).

In the operation mode, at least two different pressure levels are applied to the plastics material preforms for the expansion thereof and at least two valves are used for this application (to control the application).

Particularly preferably, at least one measured value is determined, at least at times, which is characteristic of a switching time and/or a switching time delay of at least one of the valves, wherein this measured value results from a pressure measured value and/or wherein this measured value is particularly preferably a time interval between a switching signal and a pressure change resulting from the valve switching.

It is therefore proposed within the scope of the invention to measure the switching time delay in order to allow compensation in this way. In particular, the switching time delay is determined using a pressure measured value (and, in particular, a time-pressure curve).

In particular, it is proposed that a specific pressure behavior, such as a significant pressure increase or pressure drop, is recorded, and, in particular, the time at which this pressure increase or pressure drop occurs is recorded. This time is preferably related to an (in particular electrical) switching time of the valve in order to determine the switching time delay.

In a preferred method, the pressure measured value is a pressure measured value which is characteristic of a significant change in a pressure detected by a pressure sensor.

A significant change is understood to mean a change in the pressure measured value by at least 5%, preferably by at least 10%, preferably by at least 20%, preferably by at least 30% and particularly preferably by at least 40%.

In particular, changes which occur in short periods of time are therefore taken into account, wherein a short period of time is preferably understood to be a period of time which is less than 100 ms, preferably less than 50 ms, preferably less than 30 ms, preferably less than 20 ms and particularly preferably less than 10 ms.

In a further preferred method, a switching time delay is determined which has occurred between an—in particular electrical—switching of a valve and the occurrence of the pressure measured value, wherein preferably this switching time delay is the measured value.

This means that the actual measured value to be determined is preferably the switching time delay. However, in order to determine this, it is proposed to determine the time of the effect of a valve switching (i.e., the time of the pressure change) and to infer from this time the switching time delay.

The invention therefore relates to the actual measured value to be determined, which is the switching time delay. However, unlike in the prior art, this is determined by detecting the occurrence of a pressure change and evaluating this as a measure of the switching effect.

As mentioned above, the movable carrier is preferably a rotatable carrier and, in particular, what is known as a blowing wheel.

Particularly preferably, the different pressure levels are provided from reservoirs. Particularly preferably, these reservoirs are ring buffers or annular lines. These reservoirs are preferably supplied with the flowable medium and, in particular, with compressed air by a rotary distributor. These reservoirs therefore preferably store compressed air at different pressures. Particularly preferably, these reservoirs are arranged to be stationary on the movable and, in particular, rotatable carrier. At least two such reservoirs are preferred, at least three such reservoirs are preferred, and at least four such reservoirs are particularly preferred.

Particularly preferably, at least at times, in operation mode compressed air is guided from the container to be expanded back into at least one pressure accumulator or into at least one reservoir and is therefore preferably recycled. Particularly preferably, at least one valve is used for this return or recycling. Preferably, recirculation and/or recycling into several reservoirs takes place in operation mode (in particular at different times).

In a further preferred method, the containers are stretched in their longitudinal direction during their expansion in operation mode, which is carried out in particular by a so called stretching rod which is inserted into the plastics material preforms in order to stretch them in the longitudinal direction. Particularly preferably, this movement is also controlled taking into account the individual pressure levels applied to the containers.

In a further preferred method, the said measured value is determined automatically. For example, a calibration operation can be provided during which the individual pressure measured values are recorded in order to determine the valve switching time delays. These measured pressure values (and preferably also their time curves) are preferably stored in a storage device.

Particularly preferably, these pressure measured values are determined over a specified period of time. In this way, in particular, a temporal behavior of the pressure measured values can be recorded.

Particularly preferably, the pressure is measured over a certain period of time during which a change in pressure can be detected. This pressure change is preferably used as an indication that a valve has actually been switched.

In a preferred method, a test routine is implemented in the apparatus or the forming device, which routine preferably checks and evaluates the valve switching time delay at regular intervals and, if necessary, corrects it if there is a deviation.

Therefore, the parameters stored in the machine control system for the switching time delay are particularly preferably variable and can be changed in particular by a machine control system itself. Preferably, the switching time delays are variable machine parameters which do not or no longer need to be changed or maintained by an operator.

In a preferred method, such a determination and/or measurement of the valve switching times can be carried out, for example, within a time period predefined by a user, for example once a week. Preferably, this time period can be set and/or changed in a machine parameter. The machine or apparatus preferably prompts the operator to carry out a calibration process, wherein although an automatic process would also be conceivable here.

The machine operator then starts the test routine, preferably by a command. In a preferred method, a specific number of plastics material preforms, which number, in particular, corresponds to the number of forming stations, is supplied to the machine or forming device and these are then transported (in particular without heating) to the forming stations. This can, for example, start with a forming station no. 1.

The forming station then switches the individual valves or process valves on and subsequently off one after the other at a certain rotation angle, in particular while the machine is transporting the plastics material preforms or while the transport carrier or blowing wheel is rotating. Preferably, the times of this switching of the valves are recorded.

The machine then preferably compares the point in time of the signal change to the point intime of the pressure change at the relevant pressure sensor of a blowing piston block or valve block.

There may be a small peculiarity with the exhaust valve, i.e., the outlet valve. Here, for example, pressure can initially be trapped using a second valve in order to later detect its release time. The further valves can preferably also be calibrated with an open exhaust valve.

The method is also conceivable without plastics material preforms, but the pressure changes may be less accurate. When using plastics material preforms, the volume contained in the plastics material preforms (which volume is, however, preferably constant) serves to achieve greater accuracy.

In a further preferred method, this measured value or a value derived from this measured value is taken into account in the operation mode of the machine. The value derived from this measured value may in particular be a point in time or a time period in which a pressure change was recorded.

In particular, a valve switching time delay can be measured or taken into account from the measured value, and this delay in turn can be taken into account in operation mode. Particularly preferably, the measured value and/or a value derived or determined from this measured value is stored in a machine control system of the apparatus.

Preferably, the measured value is measured outside of the operation mode and/or during a calibration operation of the apparatus and/or the forming station. In this calibration mode, it is possible that the movable carrier is moved more slowly than in an operation mode. Preferably, the carrier is rotated at a maximum of 50% of the rotational speed in operation mode, preferably at a maximum of 40%, preferably at a maximum of 30% and particularly preferably at a maximum of 20% and particularly preferably at a maximum of 10%.

Furthermore, in this calibration mode, several and preferably all valves are switched, in particular one after the other, in order to determine time delays via the pressure curve. Preferably, these valves are switched both from a first (e.g., closed) state to a second (e.g., open) state and from the second state to the first state.

In a further preferred method, the measured value is determined for several forming stations and preferably for all forming stations. It would also be possible to determine the measured value only for one or a few forming stations and to assume that the measured value will be similar at the other forming stations.

In a further preferred method, the measured value is determined for several valves and preferably for all valves of a forming station. In this way, different measured values can be determined depending on the function of the valve (e.g., switching valve for the high pressure supply or outlet valve).

It would also be possible, for example, to determine the measured values at one forming station but at all valves there and then a transfer to other forming stations is carried out. However, as mentioned above, measurements can also be taken at all stations and a mean value can be used as a basis.

The following shows options for defining the measured switching time delays as new machine parameters.

This makes it possible to determine measured values for the individual valves at one forming station and to transmit this information to all stations, and preferably also to all similar valves. The advantage of this approach is that it is very quick. However, a certain inaccuracy is disadvantageous, because in principle the same behavior is assumed for all forming stations.

In a further preferred embodiment, the measured value is determined at all forming stations and at all valves. These measured values are preferably transmitted individually to all forming stations (i.e., in particular the measured values which were measured for a specific forming station are also transmitted to the further forming stations) and are preferably used for the control thereof.

The switching times per valve are preferably averaged across all stations. This method is more accurate because it does not determine a mean value but a median. Preferably, adjustments are made at all stations.

However, it would also be possible for all forming stations based on this median and/or of the same median to be controlled. These stations will be adapted in particular in the same way.

Preferably, an error is output if individual forming stations or the valves thereof deviate too much from the mean value or median. This approach represents a good compromise and leads to sufficient precision and/or accuracy of the measurement.

In a further preferred method, the measured values are determined at all forming stations and all valves. Measurements are taken for each station and each valve and the delay times are adjusted. The advantage of this approach is the maximum possible accuracy, which is in particular also closest to monitoring. One disadvantage is the very large amount of data.

In a further preferred method, it is possible to draw conclusions about the wear behavior of the individual valves from the measured values. For example, a change in the measured value can be used to conclude that the valve in question is at a certain stage of wear or will wear out after an estimated time or operating period.

More precisely, wear behavior can be predicted. Artificial intelligence (AI) can also be used for this purpose, wherein in particular data from a plurality of machines using the same valves is used.

It is also possible to check whether individual valves or their switching times deviate significantly or whether the scatter within the forming stations suddenly becomes exceptionally large.

Preferably, it is also possible to create a test report for the individual measured values.

The invention and, in particular, automation makes it possible to avoid incorrect inputs or faulty inputs of the valve switching delay. No background knowledge is required from users. In addition, no tables or equations are required to maintain the current status, as these are preferably created automatically.

The invention allows continuous adjustment of the valve switching times for maximum switching accuracy and to exclude any overflow between the blowing stages. During commissioning, defective valves would be immediately identified because the test routine particularly preferably automatically checks each valve in a first run and can accordingly report a fault if a limit value is exceeded. This saves time when troubleshooting.

If a measurement is carried out per station and valve, even mixed operation of different valves would be conceivable if, for example, the correct replacement valve were not available.

It is therefore pointed out that it is not relevant for the invention which valve type is installed if the switching time is determined individually and taken into account accordingly. Therefore, for example, it is also possible to install a pilot valve without PWM into a valve which originally had a pilot valve with PWM. The actual switching time is easily adjusted through the calibration process.

In this way, blow molding processes are also comparable and transferable 1:1 because valve kinematics are no longer relevant.

In a further preferred method, a non-heated plastics material preform is supplied in order to determine the measured value of a forming station, preferably several forming stations, preferably all forming stations.

A non-heated plastics material perform will not expand when pressure is applied and will keep its internal volume constant. In this way, an exact determination of the pressure curve is also possible, as this is not affected by an expansion of the plastics material preform.

Preferably, pressure is applied to this cold plastics material preform and preferably both the switching time and a switching time delay and/or the reaction of a pressure sensor are determined.

In a further preferred method, a point in time of a signal change at the valve or the valves is determined, i.e., the point in time at which the change in a switching position of this valve is triggered, for example, by an electrical signal.

Particularly preferably, a point in time or period of time is determined at which a certain pressure increase or pressure change occurs. In addition, the actual valve switching time is preferably also determined. From these two points in time or times, valve switching time delays can then be determined.

Particularly preferably, pressure is applied to the unheated plastics material preform and preferably both the switching time and the reaction of the pressure sensor and, in particular, a pressure increase or a pressure change determined by the pressure sensor are determined.

In a further preferred method, the point in time of a signal change of a valve and/or the point in time of a pressure change is determined and preferably these points in time are compared to each other, in particular in order to determine the switching time delays of the relevant valve. Particularly preferably, this process is repeated for several valves of a forming stations and preferably for all valves.

In a further preferred method, the point in time of a signal change of a valve and/or the point in time of a pressure change is determined both for a switching-on process of the valve (in particular the point in time of a transition from a closed position to an open position of the valve) and for a switching-off process of the valve (in particular the point in time of a transition from an open position to a closed position of the valve).

Preferably, these points in time are compared to each other, in particular in order to determine from these comparisons a switching time delay both for the switching-on process of the valve and for the switching-off process of the valve.

It would also be possible to choose a compromise solution, i.e., to determine the switching time delays for a few valves or stations in shorter time periods and to carry out this determination for all valves during long maintenance periods. In this way, a compromise can be achieved between a short time for the calibration process and low accuracy and a less frequently repeated intensive examination of each individual valve.

In a further preferred method, at least three and preferably at least four different pressure levels are applied to the plastics material preform in operation mode. At least three and preferably at least four valves are used for this purpose.

Particularly preferably, the valve switching delays for all these valves are determined using the aforementioned method.

In a further preferred method, the flowable medium is released in the operation mode from the expanded containers, at least at times, by an outlet valve, and preferably also for this outlet valve at least one measured value is determined which is characteristic of a switching time and/or a switching time delay of this outlet valve, wherein this measured value is preferably a pressure measured value.

To determine the switching time delay of this outlet valve, a plastics material preform which is also unheated is preferably applied with compressed air and this compressed air is released via the outlet valve. In this case, too, a pressure change can be determined.

In a further preferred method, the value which is characteristic of the switching time delay and/or at least one of the recorded measured values is used to conclude the wear behavior of at least one valve and preferably the wear behavior of several valves.

For this purpose, the measured values are preferably measured more frequently and a trend is preferably determined.

In a further preferred method, a valve switching time and/or a valve switching time delay for switching the valve from a closed position to an open position is measured, in particular based on a pressure measurement.

In a further preferred method, a valve switching time and/or a valve switching time delay for switching the valve from an open position to a closed position is measured, in particular based on a pressure measurement.

Preferably, a valve switching time and/or a valve switching time delay for switching the valve from a closed position to an open position is measured, in particular on the basis of a pressure measurement, and a valve switching time and/or a valve switching time delay for switching the valve from an open position to a closed position is measured, in particular on the basis of a pressure measurement.

The valve switching time delays can vary depending on the state from which and to which the valve is switched.

The present invention is further directed to a forming device for forming plastics material preforms into plastics material containers, wherein the forming device has a movable and, in particular, rotatable carrier on which a plurality of forming stations are arranged and wherein each of these forming stations is suitable and intended to form plastics material preforms into the plastics material containers by applying a flowable and, in particular, gaseous medium, wherein in an operation mode each forming stations is suitable and intended to apply at least two different pressure levels to the plastics material preforms for the expansion thereof and each forming station has at least two valves for this application.

According to the invention, at least one processor device is provided which is suitable and intended to determine, at least at times, at least one measured value which is characteristic of a switching time and/or a switching time delay of at least one valve, wherein this measured value results from a pressure measured value which can be determined by a pressure measuring device.

Preferably, at least one measuring device is provided which is suitable and intended to determine, at least at times, at least one measured value which is characteristic of a switching time and/or a switching time delay of at least one valve, wherein this measuring device preferably is or has a pressure measuring device.

It is therefore also proposed on the apparatus side that, in particular in a calibration operation, an at least indirect measurement of a switching time or a switching time delay is carried out. This measurement is preferably carried out via a pressure measurement, wherein the pressure measurement determines at what point in time a valve actually switches or has switched.

In a further preferred embodiment, the pressure measured value is a pressure measured value which is characteristic of a significant change in a pressure detected by the pressure measuring device. It is therefore also preferably proposed on the apparatus side that a significant pressure change is searched for and this is used as an indication for a switching operation of a valve.

In a further preferred embodiment, a switching time delay can be determined which has occurred between an—in particular electrical—switching of the valve and the occurrence and/or determination of the pressure measured value, wherein preferably this switching time delay is the measured value.

Preferably, the apparatus comprises a comparison device which compares the measured pressure value and/or its course and/or pressure changes to a switching time at which the valve was actually switched (for example, a corresponding control command was issued to the valve).

Preferably, the valve is an electrically switched and/or operated valve. However, a magnetically or pneumatically switched or operated valve can also be used.

In a preferred embodiment, each forming station is assigned at least one measuring device in the form of a pressure measuring device. Particularly preferably, several pressure measuring devices are assigned to at least one forming station and preferably to several forming stations.

It would also be possible to use a pressure measuring device to measure pressure changes and switch all valves (of the same forming station). For example, the valve switching time for all valves can be determined in a sequence.

In a preferred embodiment, the apparatus comprises at least one control device which is suitable and intended to control the apparatus on the basis of at least one measured value or a value derived from this measured value.

Particularly preferably, the apparatus comprises a storage device in which the measured values and/or values derived from these measured values, such as a valve switching time delay, can be stored. Particularly preferably, the value for these valve switching time delays can be changed automatically.

In a further preferred embodiment, the apparatus comprises a time measuring device which is suitable and intended to determine a time interval between a switching time of a valve and a pressure change detected by the measuring device. This time difference is particularly preferably the value which must be taken into account when controlling the machine.

### BRIEF DESCRIPTION OF THE DRAWINGS

Further advantages and embodiments can be seen in the accompanying drawings, in which:

FIG. 1 is a representation of a forming device according to the invention;

FIG. 2 is a representation for determining the valve switching time delays.

### DETAILED DESCRIPTION OF THE INVENTION

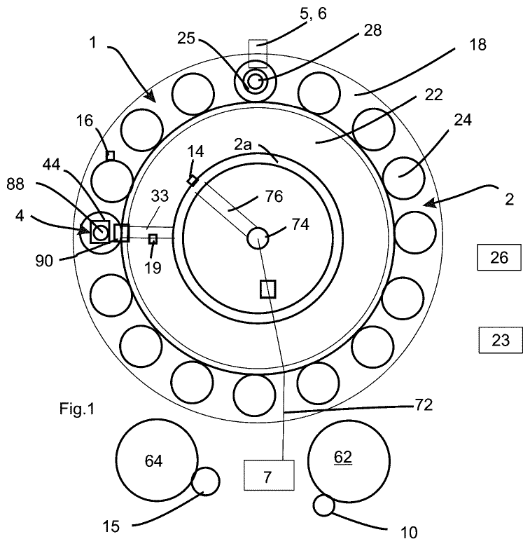

FIG. 1 shows an apparatus 1 for forming plastics material preforms 10 into plastics material containers 15. This apparatus has a transport device 2 for transporting the plastics material preforms with a rotatable carrier 22 on which a plurality of forming stations 24 are arranged. These individual forming stations each have blow molding devices 25, which in their interior form a cavity for expanding the plastics material preforms.

Reference sign 28 designates an application device, which is used to expand the plastics material preforms 10. This can be a blow nozzle, for example, which can be applied to a mouth of the plastics material preforms 10 in order to expand them. It would also be conceivable for the blowing nozzle to seal against the blow molding device. Preferably, this application device 28 is movable in a longitudinal direction and preferably exclusively in a longitudinal direction of the plastics material preforms.

Reference sign 90 designates a valve arrangement, such as a valve block, which preferably has a plurality of valve devices which control the application of different pressure levels to the plastics material preforms. Preferably, each forming station has such a valve block.

Preferably, a throttle device is also arranged on each of these valve arrangements, which controls the flow cross section of the compressed air supply to the plastics material preforms under at least one pressure. As mentioned above, at least some of these valve devices and preferably all of these valve devices can be sterilized.

In a preferred method, first, a pre-blowing pressure P1, then, at least one intermediate blowing pressure Pi which is higher than the pre-blowing pressure, and, finally, a final blow-molding pressure P2 which is higher than the intermediate blowing pressure Pi1 are applied to the plastics material preforms. Particularly preferably, the plastics material preforms are applied with a further intermediate blowing pressure Pi2 which is greater than the pressure Pi1, but smaller than the pressure P2.

In addition, a further pressure level (or a further valve) P3 can preferably be used. Here, rinsing air or cooling air for hotfill is preferably used. A process valve P3 used for this purpose is present at each individual forming station—preferably just like the valves in the blowing piston block—and its switching time can therefore be determined and/or taken into account in the same way. Monitoring is also conceivable.

The rinsing air or cooling air is preferably blown through a hollow stretching rod and particularly preferably after the final blowing P2 from the inside to the bottom of the container in order to cool it.

After the expansion of the plastics material containers, the pressures or the compressed air are preferably returned from the container to the individual pressure reservoirs.

The apparatus therefore preferably comprises an air recycling device which is suitable and intended to return compressed air from the individual forming stations into compressed air reservoirs, in particular those compressed air reservoirs which accommodate a lower pressure level.

Reference sign 88 designates a stretching rod (also referred to above as a rod-like body), which is used to stretch the plastics material preforms in their longitudinal direction. Preferably, all forming stations have such blowing molds 25 as well as stretching rods 88. This stretching rod is preferably a component of a stretching unit designated as 4. The stretching rod 88 is movable (preferably also exclusively) in the longitudinal direction of the plastics material preforms 10 (wherein the rotation of the carrier 22 is disregarded here).

Reference sign 44 schematically indicates a drive device which is suitable and intended to drive or move the rod-like body. Preferably, this drive device is an electric motor. Preferably, such a drive device is assigned to each forming station.

Preferably, the apparatus has a control device which controls this drive device and, in particular, controls it taking into account the pressure application.

Particularly preferably, the control device also takes into account the individual valves (not shown) which apply the flowable medium and, in particular, the compressed air to the plastics material preforms.

Reference sign 5 denotes a detection device which is suitable and intended to detect a position of the stretching rod or the rod-like body (in particular in the longitudinal direction of the plastics material preforms). Preferably, this detection device 5 is also suitable and intended to detect a force which acts on the rod-like bodies during their movement.

Preferably, this detection device 5 evaluates data from the drive device 44 in order to determine the position or force. For example, the drive device can have position sensors, or current or voltage values with which the drive device is operated can be determined.

Preferably, the number of these forming stations 24 is between 2 and 100, preferably between 4 and 60, preferably between 6 and 40.

In operation mode, the plastics material preforms 10 are supplied to the apparatus via a first transport device 62 such as, in particular but not exclusively, a transport starwheel. The plastics material containers 15 are transported away via a second transport device 64.

Reference sign 7 designates a pressure providing device, such as a compressor or also a compressed-air connection. The compressed air is conveyed via a connecting line 72 to a rotary distributor 74 and from there provided via a further line 76 to a first compressed air reservoir 2a, which in this case is an annular channel.

Thus, preferably, such rotary distributor serves the purpose of feeding air from a stationary part of the apparatus into a rotating part of the apparatus.

In addition to this illustrated annular channel 2a, further annular channels are preferably provided, which are, however, hidden by the annular channel 2a in the representation shown in FIG. 1, for example due to lying underneath it. Accordingly, one pressure reservoir each is available for storing the pressure P2, and the intermediate blowing pressures Pi1 and Pi2 and the pressure P1.

Reference sign 33 designates a connecting line, which delivers the compressed air to a forming station 24 or its valve block 90. Preferably, each of the annular channels is connected to all forming stations via corresponding connecting lines. This connecting line 33 is preferably arranged in the rotating part of the apparatus.

Reference sign 18 schematically designates an optional clean room, which is preferably formed here in the shape of a ring and surrounds the transport path of the plastics material preforms 10. Preferably, a (geometric) axis of rotation with respect to which the transport carrier 22 is rotatable is arranged outside the clean room 18. Preferably, the clean room 18 is sealed from the non-sterile environment by a sealing device, which preferably has at least two surge tanks. Preferably, this clean room is of ring-shaped or toroidal design.

The apparatus preferably has a plurality of measuring and/or sensor devices, which are used to control the apparatus. Reference sign 14 designates a pressure measuring device, which measures an air pressure within the compressed-air reservoir 2a. Preferably, the other compressed-air reservoirs also have corresponding pressure measuring devices.

Reference sign 16 designates a further pressure measuring device, which measures an air pressure, in particular a container internal pressure of the plastics material preform to be expanded. Preferably, such a pressure measuring device is assigned to each forming station.

This measuring device is suitable and intended in particular to determine a pressure over a predefined period of time outside of an operation mode, so that this measurement can be used to determine whether individual valves are switched.

Preferably, the valve devices themselves also each have at least one and preferably several sensor devices, such as pressure measuring devices.

Reference sign 19 also schematically designates a flow measurement device, which determines a flow rate of the blown air from a compressed air reservoir to the valve block 90 of a forming station 24. Preferably, corresponding flow-measuring devices are each arranged between a compressed air reservoir and all forming stations.

Further flow measurement devices can also be assigned between the further compressed air reservoirs and the respective forming stations.

Furthermore, position detecting devices are preferably also provided, as mentioned above, which can detect positions of the stretching rods of the individual forming stations.

Reference sign 23 designates a control device which controls and, in particular, regulates the apparatus 1. This control device is preferably also able to change the working parameters of the apparatus and, in particular, the settings of the stretching unit.

The valve switching times and/or the valve switching time delays of the individual valves can also be stored in this control device 23. Preferably, these valve switching times and/or valve switching delays can be changed and, particularly preferably, can also be changed automatically.

Preferably, the apparatus comprises a processor device (not shown) which is suitable and intended to determine valve switching time delays from measured pressure curves and valve switching times.

Preferably, the control device is suitable for controlling and preferably regulating the apparatus, and, in particular, also the valves, taking into account the individual valve switching delays.

The control device accordingly controls, in particular, the individual valve devices and hence the application of the individual pressure levels to the plastics material preforms. In addition, the control device preferably also controls a movement of the stretching rods of the individual shaping stations. Preferably, the control device also controls movements of the application devices, i.e., the blowing nozzles. As mentioned, this control device can preferably also adjust the settings of the individual throttle devices.

The control device is preferably suitable for controlling the points in time at which the application devices are applied to the plastics material preforms and/or the points in time at which the blow molding devices are again lifted from the plastics material preforms, and, in particular, also for changing these points in time.

Reference sign 26 designates a storage device, in which, in particular, measured variables are stored, in particular pressure values and flow values, but also corresponding working parameters. Preferably, these respective values are stored with a temporal assignment. Preferably, this storage device 26 is also suitable and intended to store positions of the individual stretching rods or rod-like bodies.

Preferably, the storage device 26 is also suitable for storing reference data, in particular from recorded pressure curves and/or from measured pressure changes and/or from determined valve switching time delays.

Preferably, these values can be stored continuously and, in particular, over long periods of time of a machine operation. The control device preferably also controls or regulates the apparatus taking into account these recorded measured values and, in particular, taking into account the recorded pressure values or values derived therefrom.

Preferably, a display device is further provided which serves to output information to a machine operator. This display device can be used to output measured pressure (course) curves, for example. In addition, the valve switching time delays determined from these pressure course curves can also be displayed.

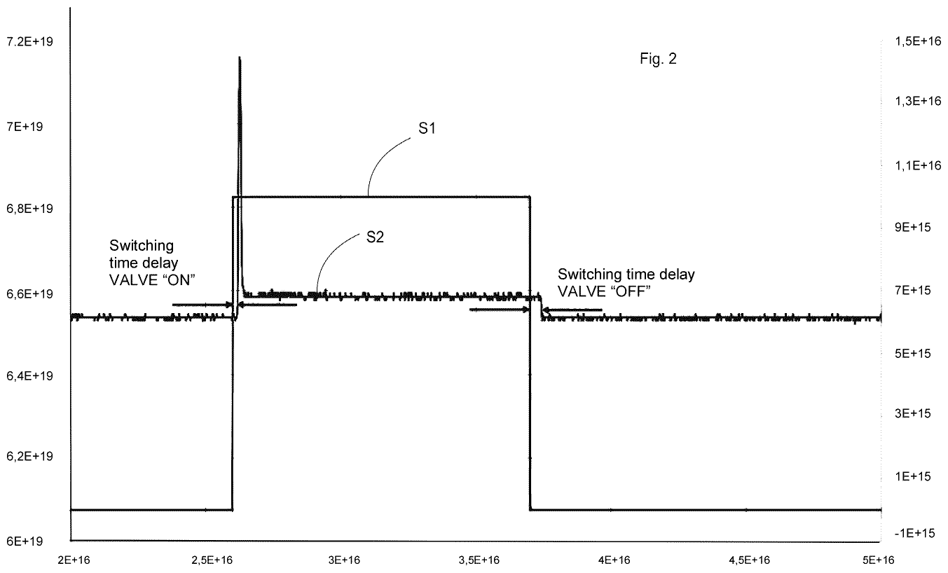

FIG. 2 shows a representation of recorded pressure curves. The reference symbol S1 refers to a switching curve for a specific valve. The time is plotted on the ordinate and, for example, a current or voltage curve is plotted on the coordinate for curve S1.

The reference symbol S2 indicates the pressure curve measured by the pressure measuring device.

A significant pressure change can be seen shortly after the detectable switching of a valve as shown in curve S1 (e.g., from the closed position to an open position, “valve on”).

The time interval between the switching time of the valve, which can be seen on the curve S1, and the actual pressure increase results in the switching time delay of the corresponding valve.

At a later point in time the valve is switched off again (valve “off”). Here, too, a pressure change occurs with a certain time delay. This is the valve switching time delay when the valve is switched off and therefore preferably when the valve is switched from an open position to a closed position.

It can be seen that these switching time delays differ depending on whether the valve is switched from a closed position to an open position or vice versa.

It is pointed out that features which were described above for the apparatus or system also apply accordingly to the method, i.e., in particular are or can be applied accordingly within the framework of the described method. Accordingly, features which were described above for the method are also disclosed correspondingly on the apparatus side, i.e., the apparatus described is also designed accordingly and with such features or properties that the method (also in the respectively specified preferred variants) can be carried out.

The applicant reserves the right to claim all features disclosed in the application documents as essential to the invention, provided that they are novel over the prior art individually or in combination. It is also pointed out that features which can be advantageous in themselves are also described in the individual figures. A person skilled in the art will immediately recognize that a particular feature described in a figure can be advantageous even without the adoption of further features from this figure. Furthermore, a person skilled in the art will recognize that advantages can also result from a combination of several features shown in individual or in different figures.

1. A method for operating a forming device for forming plastics material preforms into plastics material containers, wherein the forming device has a movable carrier on which a plurality of forming stations are arranged, wherein each of these forming stations configured to form plastics material preforms into the plastics material containers by applying a flowable medium in an operation mode, wherein in the operation mode at least two different pressure levels are applied to the plastics material preforms for the expansion thereof and at least two valves are used for this application,
wherein
at least one measured value is determined, at least at times, which is characteristic of a switching time and/or a switching time delay of at least one of the valves, wherein this measured value results from a pressure measured value.

2. The method according to claim 1,
wherein
the pressure measured value is a pressure measured value which is characteristic of a significant change in a pressure detected by a pressure sensor.

3. The method according to claim 2,
wherein
a switching time delay is determined which occurred between the switching of a valve and the occurrence of the pressure measured value.

4. The method according to claim 1,
wherein
this measured value or a value derived from this measured value is taken into account in the operation mode.

5. The method according to claim 1,
wherein
the measured value is measured outside of the operation mode.

6. The method according to claim 1,
wherein
the measured value is determined for several forming stations and/or the measured value is determined for several valves of a forming station.

7. The method according to claim 1,
wherein
to determine the at least one measured value, a non-heated plastics material preform is supplied to a forming station.

8. The method according to claim 1,
wherein
the point in time of a signal change of a valve is determined and/or the point in time of a pressure change is determined.

9. The method according to claim 8,
wherein
the point in time of a signal change of a valve and/or the point in time of a pressure change is determined both for a switching-on process of the valve and for a switching-off process of the valve and preferably these points in time are compared to each other, in particular in order to determine from these comparisons a switching time delay for both the switching-on process of the valve and the switching-off process of the valve.

10. The method according to claim 1,
wherein
in operation mode at least three different pressure levels are applied to the plastics material preform and at least three valves are used for this application.

11. The method according to claim 1,
wherein
in operation mode the flowable medium is released from the expanded containers, at least at times, by an outlet valve.

12. The method according to claim 1,
wherein
the wear behavior of at least one valve is inferred from the value which is characteristic of the switching time delay.

13. A forming device for forming plastics material preforms into plastics material containers, wherein the forming device comprises a movable carrier on which a plurality of forming stations are arranged, wherein each of these forming stations is configured to form plastics material preforms into plastics material containers by applying a flowable medium, wherein in an operation mode each forming station is configured to apply at least two different pressure levels to the plastics material preforms for the expansion thereof, and each forming station has at least two valves for this application,
wherein
at least one processor device is provided which is configured to determine, at least at times, at least one measured value which is characteristic of a switching time and/or a switching time delay of at least one valve, wherein this measured value results from a pressure measured value which can be determined by a pressure measuring device.

14. The forming device according to claim 13,
wherein
the pressure measured value is a pressure measurement which is characteristic of a significant change in a pressure detected by the pressure measuring device.

15. The forming device according to claim 14,
wherein
a switching time delay can be determined which occurred between the switching of the valve and the occurrence of the pressure measured value.
